(19) United States
(12) Patent Application Publication
(10) Pub. No.: US 2006/0164236 A1
(43) Pub. Date: Jul. 27, 2006

(54) The Use of Radio Frenquency Identification for Navigation and Location Tracking

(76) Inventors: Benjamin Peter Siegl, Blue Bell, PA (US); Steven Donald Herman, East Greenville, PA (US)

Correspondence Address: BENJAMIN PETER SIEGL, 884 VALLEY ROAD, BLUE BELL, PA, 19422, US

(21) Appl. No.: 10/905,657

(22) Filed: Jan. 14, 2005

(51) Int. Cl. G08B 1/08; G08B 13/14; G08B 5/22

(52) U.S. Cl. 340/539.13; 340/825.49; 340/572.1

(57) ABSTRACT

Radio Frequency Identification (RFID) tags have the capability of sending large strings of numbers unique to that tag using radio waves. This application looks to use RFID tags to assist navigation and location tracking within a building. The RFID tags, which have a radiation range of 3 feet, will be placed on the floor of the building. Each tag will represent an area on the floor with a number which can be accessed by passing an RFID reader over the area of the tag. A computer program in the RFID reader will be able to translate the number using a database into voice, print the information on the screen, search the database for items, or give directions to certain items. Also a program will be created so store managers can update the database and use a map of the building to easily write descriptions for each RFID tag area.

This patent application describes the use of Radio Frequency Identification (RFID) and associated technologies for navigation and location tracking. This is a novel use for RFID and compliments its convention uses for product identification.

RFID is the new cutting edge technology for product identification and it is anticipated that it will replace the barcode system. Each item with an RFID tag can be scanned from a few feet away producing identification numbers that correspond with the particular product scanned. The numbers corresponding with the RFID tags are more extensive than that of barcodes so the description of the product can be more detailed. RFID location tags are not just limited to products on a store shelf. Location Tracking and Directional Information can use this long list of numbers stored in the small tags.

The RFID tags are the first of their kind because they send information with out the need for an electric power supply to activate them. This means they can be compact and last forever. All the work in the RFID system is done by the reader. The reader sends a radio signal, very similar to that of a cell phone, that in turn powers the circuit in the RFID tag. Then the tag itself returns the signal back to reader reveling its number. Tags can be reprogrammed by the readers so that the user can specify their own numbers for ease of use. Because the signal needs to bounce back from the tag, reader needs to be within a couple feet of the tag. This may seem like a drawback but it can be used to a person's advantage.

Since the radiation range of the tag is only a couple of feet (usually about 3 feet for High Frequency tags), tags 6 feet apart will not interfere with one another. Navigation can now use the RFID tags for detailed descriptions of the surroundings. If in a grocery store hundreds of tags were placed 6 feet apart from one another, then each tag would describe an area of about 27 square feet (3 feet is the radius of the circular reach of the tag so 32 feet times pi). A person could then use an RFID reader (PDA) to access the numbers corresponding to each area by just walking over the tag. The numbers can then have a database set by the store that has a verbal description of the products in the tags specified area. The PDA would then translate the information stored in the data base to either the screen of the PDA or into a voice synthesis program.

The immediate audience that would have an interest in this project are the blind. Using vocal directions stored in the database, a blind person can navigate through a store to find the product for which they are searching. Another possible user for the program is an everyday shopper. Since the information about the different products are stored in a database, a shopper can search the database for a specific product. When the shopper walks in the door of the store and accesses the database, he or she can run a search for soup. The program would then return something a long the lines of, “Aisle 6. Left Side. 12 feet down the aisle.” A product like this could save time for the average shopper bringing them directly to their desired product.

The next advantage is the compatibility of the product to the store. Since the information is stored in sticker like tags, they can be placed in convenient places in the store. The store manager then has a program that maps his store and the specific 27 square foot areas within the store. If products are moved or changed, all that is necessary the change the data base is for the manager to click on the area of change and change the description. Once the tags are down they will never have to be moved. Most PDA's are equipped with wireless capabilities so the changes to the database can be automatically update as a customer walks into the door of the store. Since the tags cover small areas and the database is unique for each store, the RFID Navigation System is store specific.

The last advantage of the program within the PDA has the capability to read RFID tags in the future. RFID tags will soon replace barcodes on all products. This directly effects blind consumers looking to use RFID Navigation System. As of now, a blind consumer will use the RFID system to locate the area in the store which their product is located and then use a barcode reader to voice synthesis device (patent property of Germantown Academy, Fort Washington, Pa.) find the specific product within the area. When barcodes are obsolete and replaced by the RFID tags, a consumer can use the same RFID Navigation System devices to locate the exact location a the product within the 27 square foot area.

The flexibility of the program allows an extensive reach of consumers, from factory package workers, to shoppers in a mall. Also it allows any type of store, big or small to easily install and constantly update the Navigation System.

What is claimed is:

1. This application claims the right to the use of RFID tags for proposes of navigation, specifically the use of a database with corresponding RFID numbers that gives a description of the area surrounding the unique number. This includes the use of RFID tags to designate areas of a building or store which then can be compared to a database for a description and the area within the building or store.

2. This application directly claims the right to a computer program which enables a user to scan RFID tags as used in navigation. A program which can use a database to access a description of an area and either print it on the screen of a computerized device or read it aloud using a voice synthesis program on the computer. This program also can be used to search the database for desired items and their location. Lastly the program can use the information and location of other RFID tags to give detailed directions to a specified area within the building or store.

3. This application also claims a second program which the database and the RFID numbers are created. A program designed for store managers that maps out the building or store by the areas created by RFID tags. The program allows the manager to edit or write the area's description and list of products within the area. The database will update itself according the changes specified by the store manager.
